(19) United States
(12) Patent Application Publication
(10) Pub. No.: US 2010/0001961 A1
(43) Pub. Date: Jan. 7, 2010

(54) Information Handling System Settings Adjustment

(75) Inventors: Christian Dieterle, Austin, TX (US); Bradley Michael Lawrence, Austin, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 12/167,245

(22) Filed: Jul. 3, 2008

(51) Int. Cl. G06F 3/041

(52) U.S. Cl. 345/173

(57) ABSTRACT

A settings adjustment system includes a settings adjustment engine. A key is coupled to the settings adjustment engine. The settings adjustment engine is operable to detect a user selection of the key. A touchpad is coupled to the settings adjustment engine. In response to detecting the user selection of the key, the settings adjustment engine is operable to detect a user gesture on the touchpad, determine a settings adjustment from that user gesture, and change a setting according to the settings adjustment.

### BACKGROUND

The present disclosure relates generally to information handling systems, and more particularly to adjusting the settings for an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHSs typically allow a user of the IHS to adjust the settings of that IHS to reflect the users desired operating parameters of the IHS. The changing of such IHS settings raises a number of issues.

For example, in order to adjust the settings related to a touchpad on the IHS, the user typically must navigate through a number of menus presented on an IHS display (e.g., Settings>Control Panel>Mouse) and then choose from numerous tabs in order to adjust the touchpad specific settings. Such navigation is very time consuming and can be confusing to a user, who may neglect changing the IHS settings due to the difficulty in determining where and how to do so. Failure in attempts to adjust IHS settings can result in a negative user experience.

Accordingly, it would be desirable to provide an improved system for adjusting the settings on an IHS which avoids the issues discussed above.

### SUMMARY

According to one embodiment, a settings adjustment system includes a settings adjustment engine, a key coupled to the settings adjustment engine, wherein the settings adjustment engine is operable to detect a user selection of the key, and a touchpad coupled to the settings adjustment engine, wherein in response to detecting the user selection of the key, the settings adjustment engine is operable to detect a user gesture on the touchpad, determine a settings adjustment from that user gesture, and change a setting according to the settings adjustment.

### BRIEF DESCRIPTION OF THE DRAWINGS

FIG. 1 is a schematic view illustrating an embodiment of an IHS.

FIG. 2a is a schematic view illustrating an embodiment of a settings adjustment system.

FIG. 2b is a perspective view illustrating an embodiment of the settings adjustment system of FIG. 2a.

FIG. 3a is a flow chart illustrating an embodiment of a method for adjusting settings on an IHS.

FIG. 3b is a schematic view illustrating an embodiment of a user gesture used with the settings adjustment system of FIGS. 2a and 2b.

FIG. 3c is a schematic view illustrating an embodiment of a user gesture used with the settings adjustment system of FIGS. 2a and 2b.

FIG. 3d is a schematic view illustrating an embodiment of a user gesture used with the settings adjustment system of FIGS. 2a and 2b.

FIG. 3e is a schematic view illustrating an embodiment of a user gesture used with the settings adjustment system of FIGS. 2a and 2b.

FIG. 3f is a schematic view illustrating an embodiment of a user gesture used with the settings adjustment system of FIGS. 2a and 2b.

FIG. 3g is a schematic view illustrating an embodiment of a portion of a user gesture used with the settings adjustment system of FIGS. 2a and 2b.

FIG. 3h is a schematic view illustrating an embodiment of a portion of the user gesture used with the settings adjustment system of FIGS. 2a and 2b, the other portion of which is illustrated in FIG. 3g.

FIG. 3i is a perspective view illustrating an embodiment of the settings adjustment system of FIGS. 2a and 2b with a user interface displayed on the touchpad.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

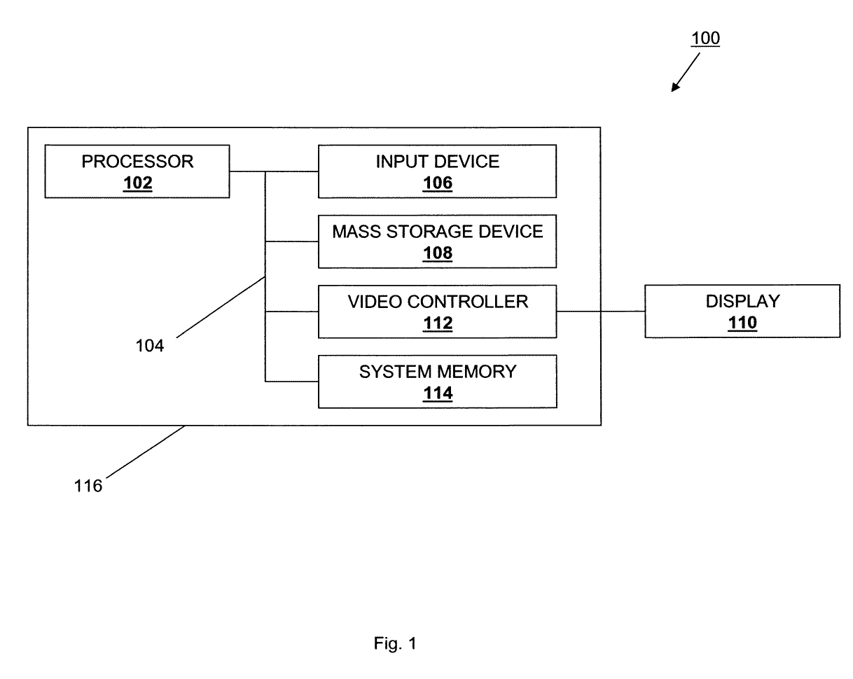

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

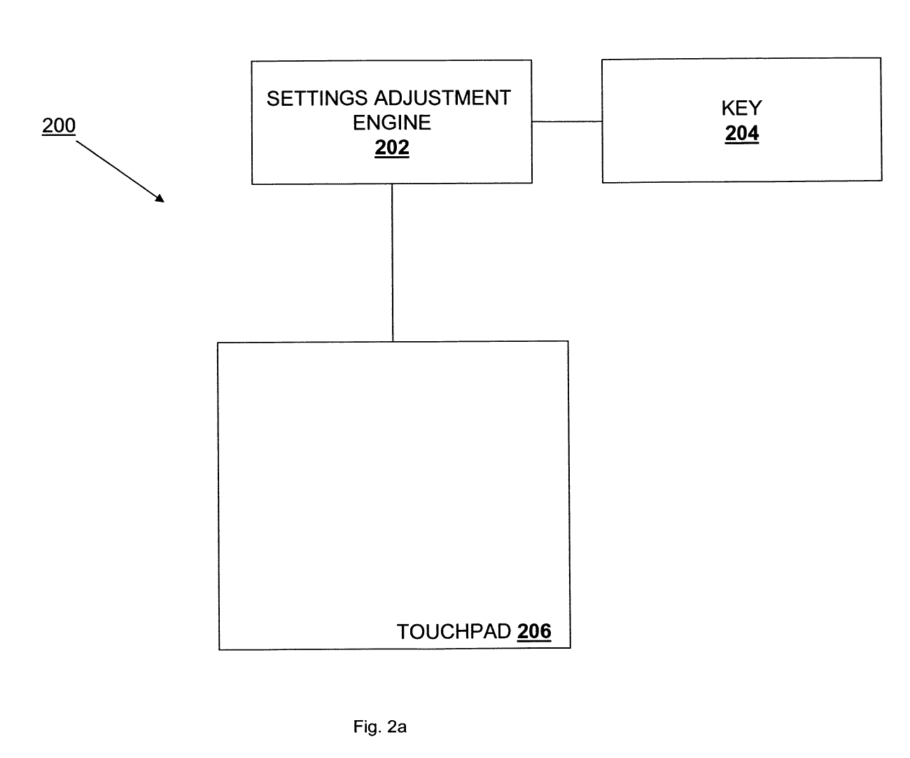

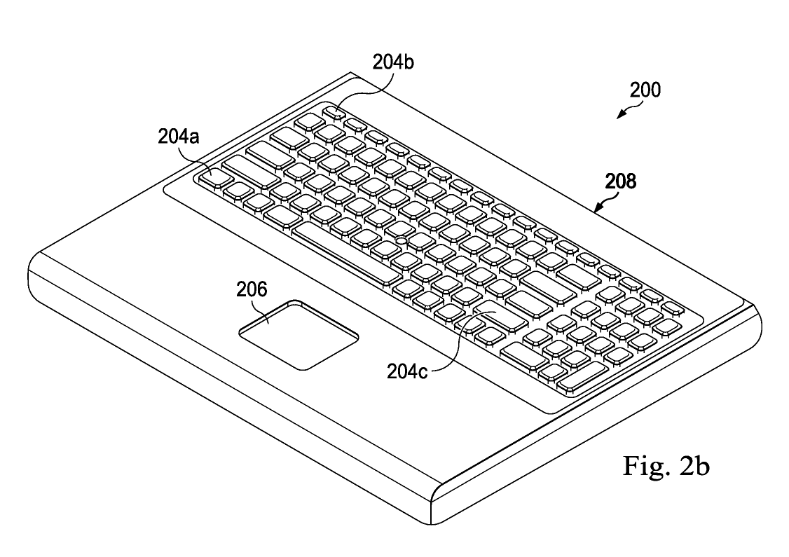

Referring now to FIGS. 2a and 2b, a settings adjustment system 200 is illustrated. The settings adjustment system 200 includes a settings adjustment engine 202 which may include, for example, software stored on a computer-readable medium on the IHS 100, described above with reference to FIG. 1, a Basic Input/Output System (BIOS) in the IHS 100, firmware in the IHS 100, and/or utilizing a variety of other IHS components known in the art to allow the functionality described in further detail below. In an embodiment, the settings adjustment engine 202 may be coupled to the processor 102 and the storage 108 of the IHS 100, described above with reference to FIG. 1, and/or to other components of the IHS 100. The settings adjustment engine 202 is coupled to a key 204 and a touchpad 206. In an embodiment, the key 204 and the touchpad 206 are part of the input device 106 on the IHS 100, described above with reference to FIG. 1. In the embodiment illustrated in FIG. 2b, the IHS 100 includes a keyboard 208 that includes a plurality of keys 204 such as, for example, the keys 204a, 204b and 204c illustrated in FIG. 2b. In an embodiment, the key 204a may be a function key for a IHS, a key dedicated for adjusting settings, and/or a variety of other keys known in the art. The keyboard 208 also includes the touchpad 206 located adjacent the key 204 on the keyboard 208. In an embodiment, the keyboard 208 is a keyboard that is located on a portable or notebook computer. In an embodiment, the keyboard 208 is a separate component of a desktop computer. While examples of keyboards have been described, one of skill in the art will recognize that the settings adjustment system 200 may include many different configurations that include the key 204 and the touchpad 206.

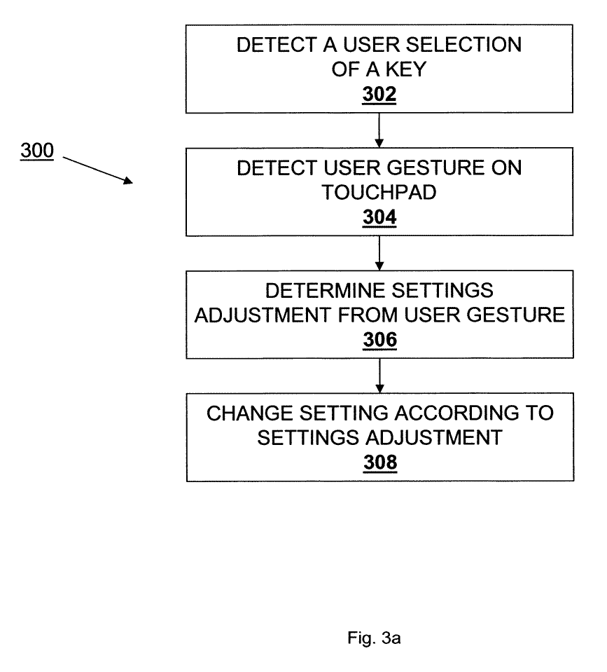

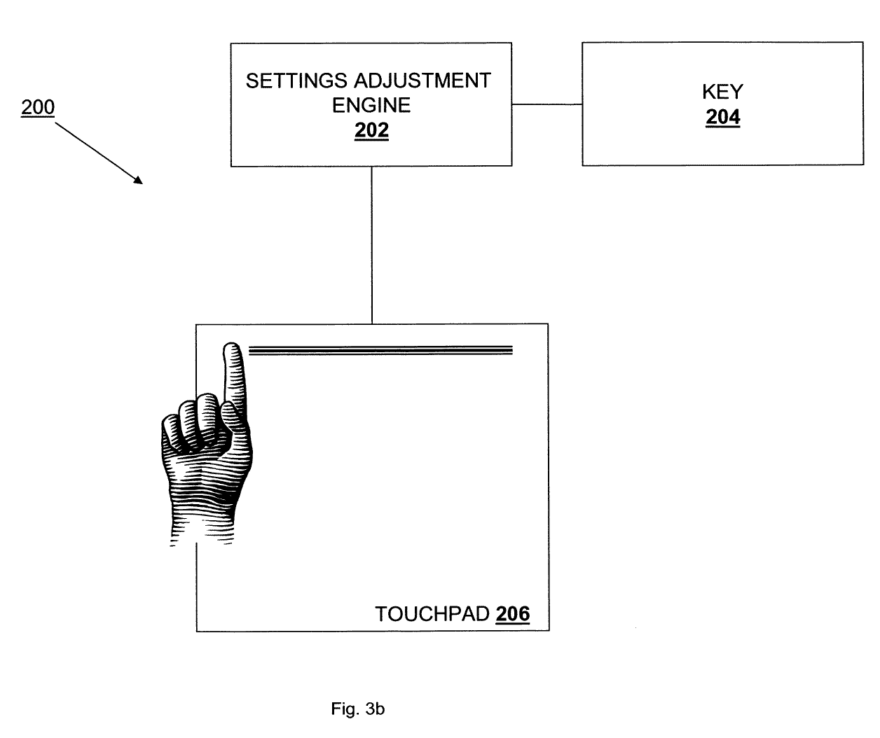

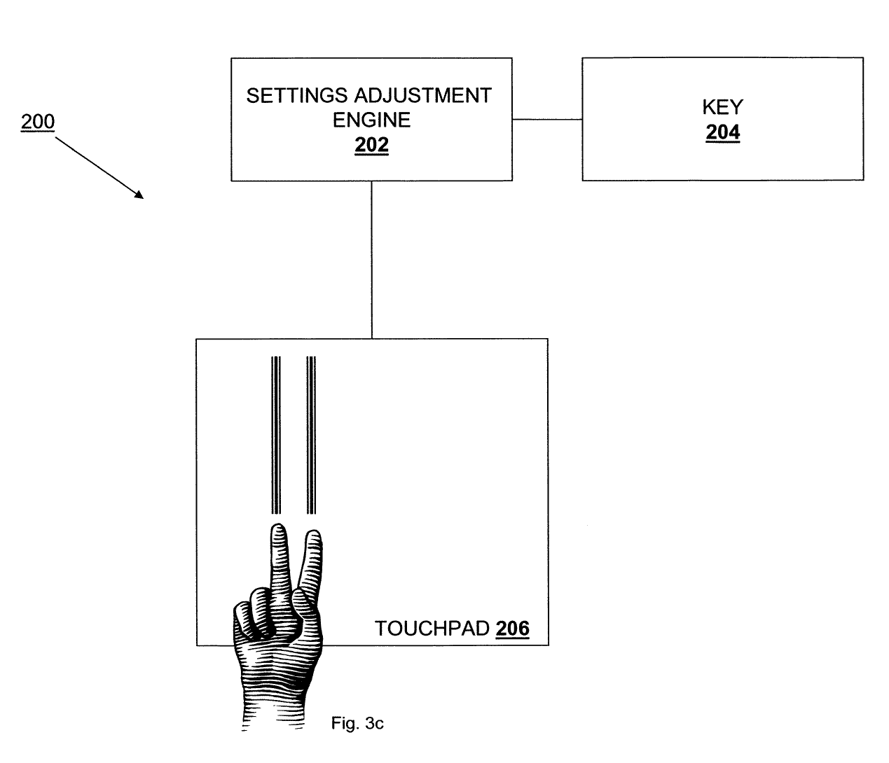

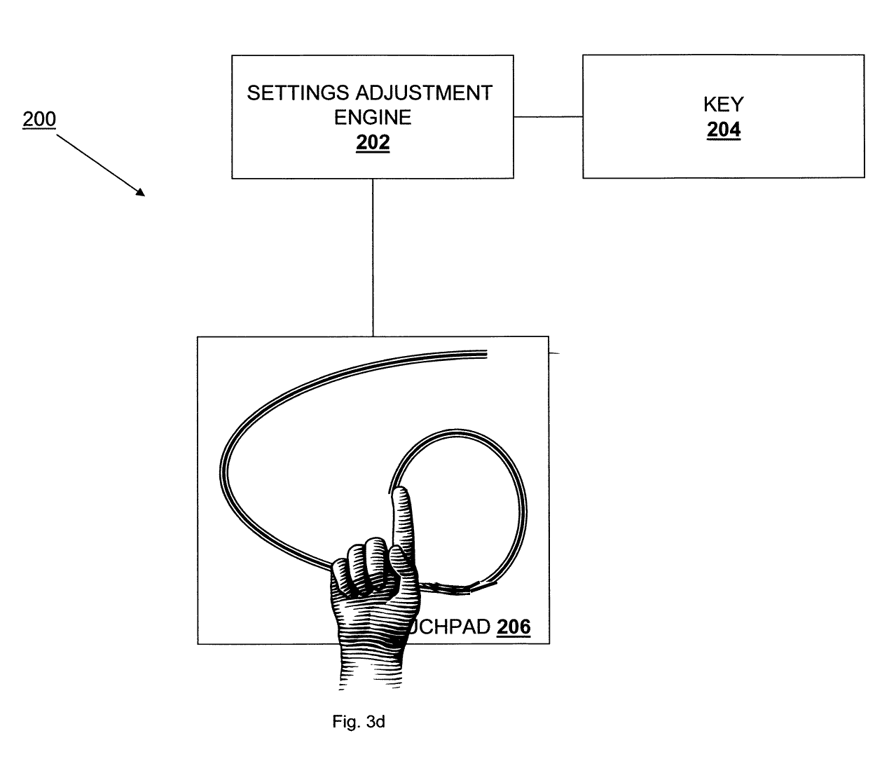

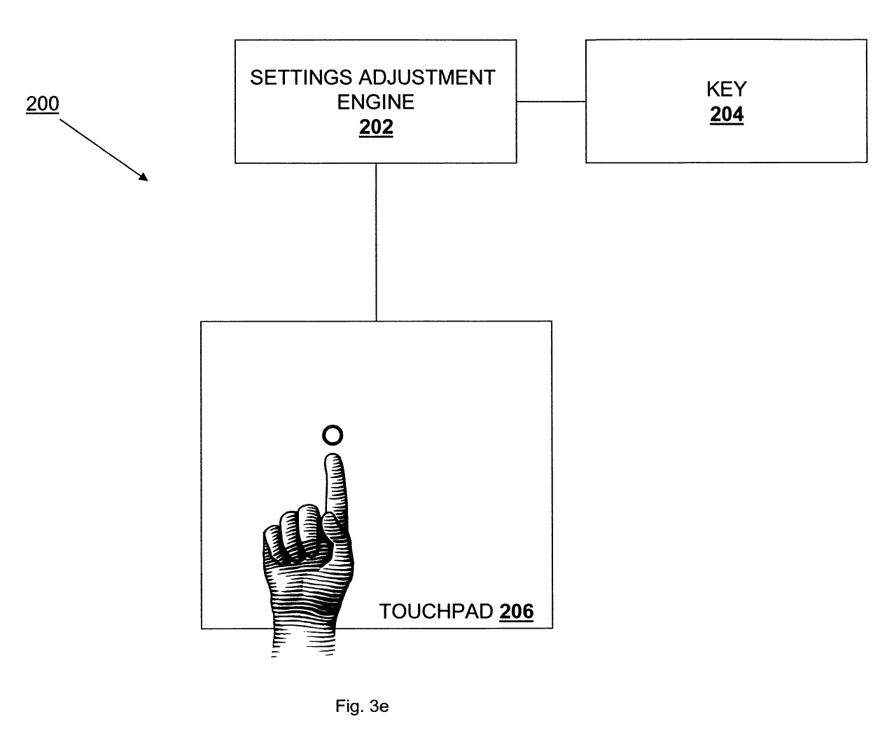

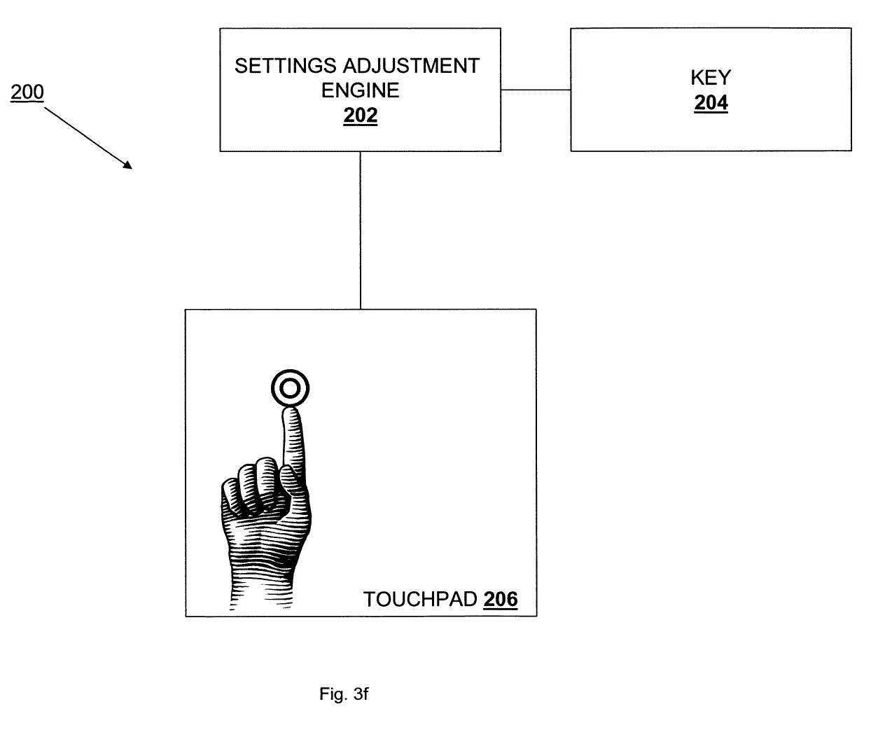

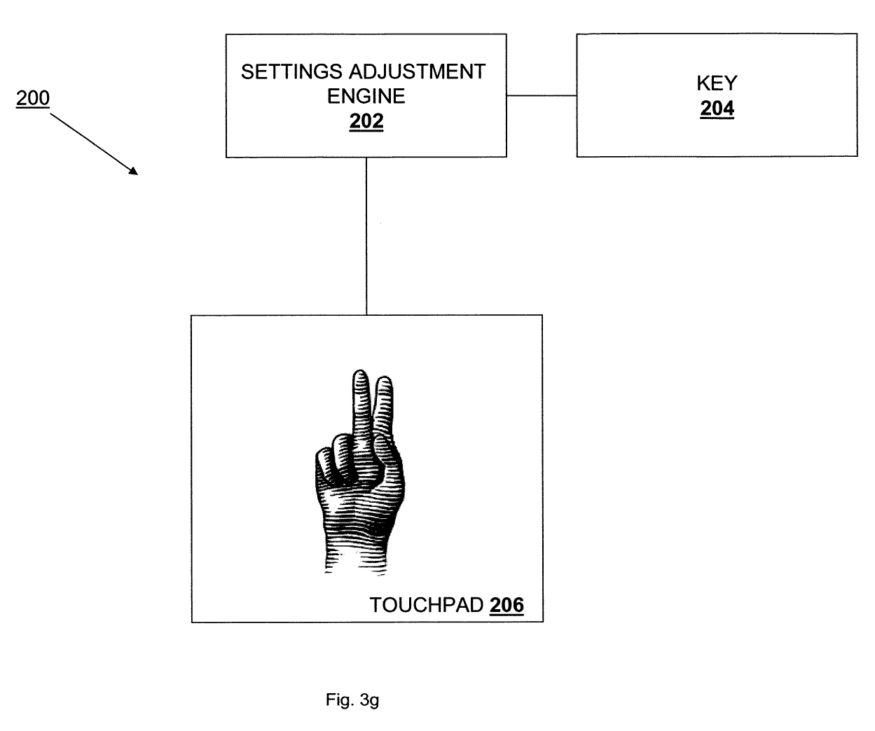

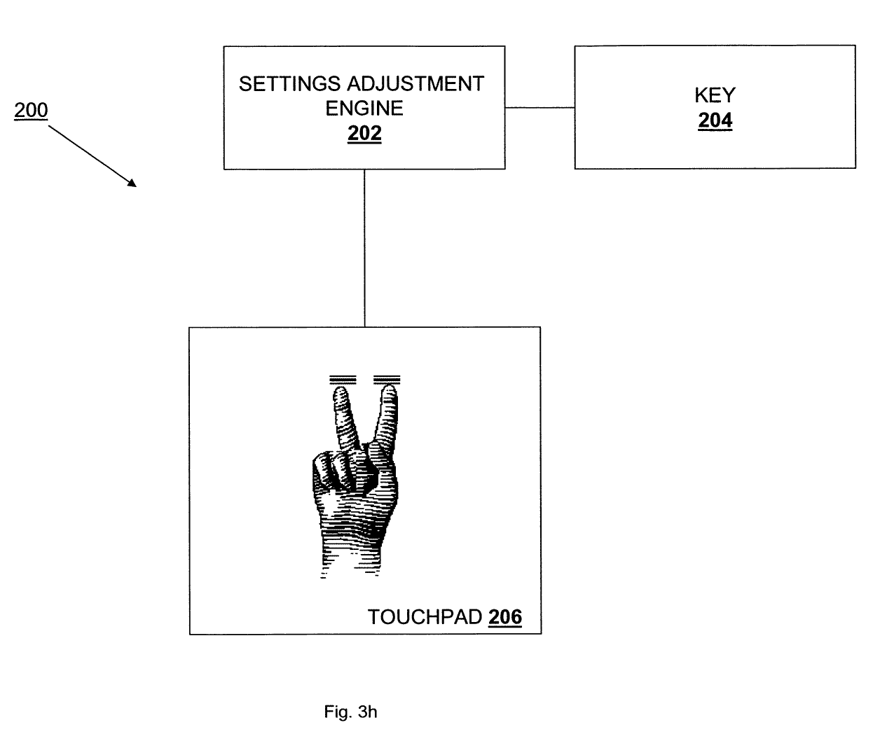

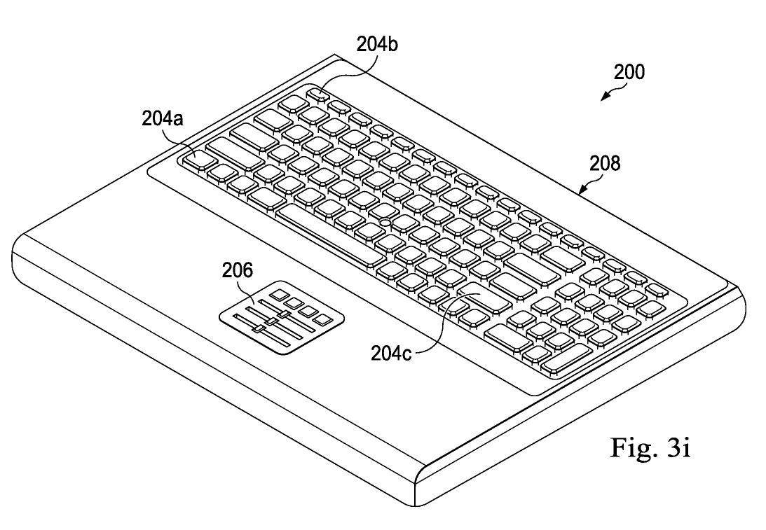

Referring now to FIGS. 2a, 2b and 3a, a method 300 for adjusting the settings on an IHS is illustrated. The method 300 begins at block 302 where the settings adjustment engine 202 detects a user selection of a key. In an embodiment, the settings adjustment engine 202 includes the BIOS on the IHS 100, and block 302 includes the BIOS recognizing a keystroke of one of the keys 204. In an embodiment, the user selection of the key 204 is a user selection of the function key 204a. However, any key 204 on the keyboard 208 may be designated for providing settings adjustment system functionality, as is described in further detail below. In an embodiment, the user selection of the key 204 may include the depressing and releasing of the key 204. In an embodiment, the user selection of the key may include the depressing and holding of the key 204 in the depressed position. In an embodiment, upon detection of the user selection of the key 204, the settings adjustment engine 202 temporarily disables the touchpad 206 from its normal operation and enables a settings adjustment mode of the touchpad 206 for use in changing settings on the IHS 100.

Referring now to FIGS. 2a, 2b and 3a, the method 300 continues to block 304 where the settings adjustment engine 202 detects a user gesture on the touchpad 206. Upon the user selection of the key 204 that results in the settings adjustment engine 202 enabling the settings adjustment mode of the touchpad 206, the user may perform a variety of gestures on the touchpad 206 in order to change the settings of the IHS 100. A variety of different user gestures and their results in the method 300 are described below. However, the examples set forth should not be interpreted as limiting, as one of skill in the art will recognize a variety of gestures and subsequent results that will fall within the scope of the disclosure.

For example, FIG. 3b illustrates a user gesture on the touchpad 206 that includes the movement of a single finger of the user across the touchpad 206. In an embodiment, the user gesture illustrated in FIG. 3b may be modified from the horizontal motion shown to a vertical or diagonal motion, with each motion associated with a different settings adjustment, described in further detail below. FIG. 3c illustrates a user gesture on the touchpad 206 that includes the movement of multiple fingers of the user across the touchpad 206. In an embodiment, the user gesture illustrated in FIG. 3c may be modified from the two finger gesture shown to include any number of fingers or other input contacts with the touchpad 206, with each motion associated with a different settings adjustment, described in further detail below. FIG. 3d illustrates a user gesture on the touchpad 206 that includes the movement of at least one finger of the user in a circular or spiral pattern about the touchpad 206. FIG. 3e illustrates a user gesture on the touchpad 206 that includes a ‘tap’, i.e., contact of at least one finger of the user with the touchpad 206. FIG. 3f illustrates a user gesture on the touchpad 206 that includes a ‘double tap’, i.e., repeated contact of at least one finger of the user with the touchpad 206. FIGS. 3g and 3h illustrate a user gesture on the touchpad 206 that includes either of a ‘pinch’ or ‘reverse pinch’, i.e., the contact of at least two fingers of the user with the touchpad 206 and the movement of those at least two fingers either towards or away from each other. Any of the gestures described above may be modified or combined (e.g., multiple finger ‘taps’ or ‘double taps’) and associated with a settings adjustment, described in further detail below.

In response to detecting the user gesture on the touchpad 206, the method 300 proceeds to block 306 where the settings adjustment engine 202 determines a settings adjustment from the user gesture detected in block 304 of the method 300. In an embodiment, a plurality of user gestures on the touchpad 206 may have been previously associated with settings on the IHS 100. In an embodiment, the user may have previously customized the association of gestures and settings on the IHS 100 by, for example, selecting an IHS 100 setting adjustment and then selecting a gesture on the touchpad 206 to associate with that settings adjustment. For example: the user gesture illustrated in FIG. 3b may be associated with adjusting the sensitivity of the touchpad 206 or adjusting the scrolling speed of the touchpad 206; the user gesture illustrated in FIG. 3c may be associated with adjusting the brightness of a screen on the display 110, described above with reference to FIG. 1; the user gesture illustrated in FIG. 3d or some other similar rotational gesture may be associated with adjusting the volume of speakers (not illustrated) coupled to the IHS 100; the user gesture illustrated in FIG. 3e may be associated with selecting an on or off condition of the touchpad 206 (i.e., the user gesture may allow the touchpad 206 to be disabled); the user gesture illustrated in FIG. 3f may be associated with adjusting the ‘double tap’ speed of the touchpad 206 (i.e., the user gesture would set the ‘double tap’ speed to the rate at which the user gesture was performed); and the user gesture illustrated in FIGS. 3g and 3h may be associated with adjusting the resolution of the screen of the display 110. While a number of settings adjustments have been described, it is not intended that the present disclosure be limited to such examples, as a variety of others settings are envisioned as falling within the scope of this disclosure such as, for example, adjusting the screen source for the display 110 (e.g., between an LCD display and a projection display coupled to the IHS 100), adjusting the drag lock of the touchpad 206, adjusting the brightness of the backlighting on the keyboard 208, adjusting the cursor speed of the touchpad 206, and/or a variety of other IHS settings known in the art.

In an embodiment, upon the detection of the user selection of the key 204 in block 304 of the method 300, a visual feedback may be provided on a screen of the display 110 in order to allow the user to visualize the adjustment being made to the IHS setting. For example, the user gesture being performed may be associated with adjusting the volume of speakers coupled to the IHS 100, and upon detection of the user gesture on the touchpad 206, the visual feedback may include a volume gauge that increases or decreases with the user gesture position and movement on the touchpad 206. In another example, the user gesture being performed may be associated with adjusting the resolution of a screen on the display 110, and the visual feedback may include on-screen text that toggles between resolutions (e.g., 800×600, 1024×768, 1280×800, etc.) based on the user gesture position and movement on the touchpad 206.

Upon determining a settings adjustment from the user gesture at block 306 of the method 300, the settings adjustment engine 202 changes an IHS setting according to the settings adjustment. As described above, the user gestures detected on the touchpad 206 in block 304 of the method 300 are associated with settings adjustments. Those settings adjustments are associated with settings on the IHS such that the settings adjustment engine 202 may determine the settings adjustment associated with the user gesture, use that settings adjustment to change an IHS setting according to that settings adjustment, and then save that setting in the storage 108. For example: the user gesture illustrated in FIG. 3b may be associated with adjusting the sensitivity of the touchpad 206 or adjusting the scrolling speed of the touchpad 206 and the settings adjustment engine 202 may change the sensitivity of the touchpad 206 or the scrolling speed of the touchpad 206 according the settings adjustment determined from that user gesture; the user gesture illustrated in FIG. 3c may be associated with adjusting the brightness of a screen on the display 110, described above with reference to FIG. 1, and the settings adjustment engine 202 may change the brightness the screen according the settings adjustment determined from that user gesture; the user gesture illustrated in FIG. 3d or some other similar rotational gesture may be associated with adjusting the volume of speakers (not illustrated) coupled to the IHS 100, and the settings adjustment engine 202 may change the volume of the speakers according the settings adjustment determined from that user gesture; the user gesture illustrated in FIG. 3e may be associated with selecting an on or off condition of the touchpad 206 (i.e., the user gesture would allow the touchpad 206 to be disabled), and the settings adjustment engine 202 may disable or enable the touchpad 206 according the settings adjustment determined from that user gesture; the user gesture illustrated in FIG. 3f may be associated with adjusting the ‘double tap’ speed of the touchpad 206 (i.e., the user gesture may set the ‘double tap’ speed to the rate at which the user gesture was performed), and the settings adjustment engine 202 may change the ‘double tap’ speed according the settings adjustment determined from that user gesture; and the user gesture illustrated in FIGS. 3g and 3h may be associated with adjusting the resolution of the screen of the display 110, and the settings adjustment engine 202 may change the resolution an area of the screen according the settings adjustment determined from that user gesture.

Referring now to FIG. 3i, in an embodiment, upon the detection of the user selection of the key 204, the settings adjustment engine 202 may enable a graphical user interface on the touchpad 206, as illustrated in FIG. 3i. In an embodiment, the graphical user interface on the touchpad 206 is operable to display, for example, icons, text, sliders, and/or a variety of other user interface elements known in the art. The user may then provide the user gesture on the touchpad 206 using the graphical user interface (e.g., by selecting an icon, moving a slider, selecting text, or otherwise interacting with a graphic displayed on the graphical user interface) in order to change settings on the IHS. In an embodiment, the graphical user interface may be enabled by a backlit LCD located adjacent the touchpad 206. Thus, a system and method are provided that allow a user of an IHS to quickly and intuitively adjust settings on an IHS.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A settings adjustment system, comprising:
a settings adjustment engine;
a key coupled to the settings adjustment engine operable to temporarily disable an associated touchpad, wherein the settings adjustment engine is operable to detect a user selection of the key; and
the touchpad coupled to the settings adjustment engine, wherein in response to detecting the user selection of the key, the settings adjustment engine is operable to detect a user gesture on the touchpad, determine a settings adjustment from that user gesture, and change a setting according to the settings adjustment.

2. The system of claim 1, wherein the setting that the settings adjustment engine is operable to change comprises a touchpad setting.

3. The system of claim 1, wherein the setting that the settings adjustment engine is operable to change comprises a display setting.

4. The system of claim 1, wherein in response to detecting the user selection of the key, the settings adjustment engine is operable to activate a graphical user interface on the touchpad.

5. The system of claim 4, wherein the user gesture on the touchpad comprises a user interaction with a graphic displayed on the graphic user interface.

6. The system of claim 1, wherein in response to detecting the user selection of the key, the settings adjustment engine is operable to present a visual feedback on a display that is coupled to the settings adjustment engine.

7. The system of claim 1, wherein the settings adjustment engine comprises a basic input/output system (BIOS) in an information handling system.

8. An information handling system (IHS), comprising:
a processor;
a storage coupled to the processor;
a settings adjustment engine coupied to the processor and the storage; and
an input device coupled to the settings adjustment engine, the input device comprising:
a key coupled to the settings adjustment engine operable to temporarily disable an associated touchpad, wherein the settings adjustment engine is operable to detect a user selection of the key; and
the touchpad coupled to the settings adjustment engine, wherein in response to detecting the user selection of the key, the settings adjustment engine is operable to detect a user gesture on the touchpad, determine a settings adjustment from that user gesture, and save a setting in the storage according to the settings adjustment.

9. The system of claim 8, wherein the setting that the settings adjustment engine is operable to save in the storage comprises a touchpad setting.

10. The system of claim 8, wherein the setting that the settings adjustment engine is operable to save in the storage comprises a display setting.

11. The system of claim 8, wherein in response to detecting the user selection of the key, the settings adjustment engine is operable to activate a graphical user interface on the touchpad.

12. The system of claim 11, wherein the user gesture on the touchpad comprises a user interaction with a graphic displayed on the graphic user interface.

13. The system of claim 8, further comprising:
a display coupled to the settings adjustment engine, wherein in response to detecting the user selection of the key, the settings adjustment engine is operable to present a visual feedback on the display.

14. The system of claim 8, wherein the settings adjustment engine comprises a basic input/output system (BIOS) in an IHS.

15. A method for adjusting the settings on an information handling system (IHS), comprising:
detecting a user selection of a key;
coupling a settings adjustment engine to the key;
coupling a touchpad to the settings adjustment engine; and
upon detection of the user selection of the key, the settings adjustment engine temporarily disabling operation of the touchpad and enabling a settings adjustment mode of the touchpad for use in changing settings on the IHS.

16. The method of claim 15, further comprising:
activating a graphical user interface on the touchpad in response to detecting the user selection of the key.

17. The method of claim 16, wherein the user gesture on the touchpad comprises a user interaction with a graphic displayed on the graphic user interface

18. The method of claim 16, further comprising:
presenting a visual feedback on a display in response to detecting the user selection of the key.

19. The method of claim 16, wherein the changing a setting comprises changing a touchpad setting.

20. The method of claim 16, wherein the changing a setting comprises changing a display setting.
